(19) United States
(12) Patent Application Publication
(10) Pub. No.: US 2004/0007982 A1
(43) Pub. Date: Jan. 15, 2004

(54) Automatic backup system for highway lighting

(76) Inventor: Gary L. Rapp, Athens, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/617,989

(22) Filed: Jul. 10, 2003

Related U.S. Application Data
(60) Provisional application No. 60/394,985, filed on Jul. 10, 2002.

(51) Int. Cl. B60Q 1/00

(52) U.S. Cl. 315/77; 315/82

(57) ABSTRACT

A highway light with an automatic backup lighting system includes a voltage supply, a switching mechanism electrically connected with the voltage supply, a current sensing device electrically connected with the voltage supply and the switching mechanism, a primary lamp electrically connected with the current sensing device and the voltage supply, and a secondary lamp electrically connected with the switching mechanism, wherein the current sensing device activates the switching mechanism to direct voltage to the secondary lamp when the current sensing mechanism senses low amperage from its connection with the primary lamp.

### CROSS-REFERENCES

This application claims the priority of provisional application Serial No. 60/394,985, filed Jul. 10, 2002.

### FIELD OF THE INVENTION

This invention generally relates to electrical lighting systems and more particularly to an automatic backup system for highway lighting.

### BACKGROUND OF THE INVENTION

Roadways and, in particular, highways present some of the most challenging outdoor lighting applications. These areas require sufficient luminescence to light large areas with no other available light sources, are frequently located in rural and remote locations that are not easily accessible to maintenance personnel, and are often the subject of vandalism. It is common practice to mount highway lights on towers rising thirty feet or more above the roadway surface. While lights in some areas are equipped with means to lower the lights to ground level, maintenance crews in many areas must be equipped with means for elevating the workers to the level of the lights.

Due to these conditions, maintaining and, in particular, changing spent bulbs in these lights is neither easy nor quick. The cost involved in equipping and sending maintenance crews out on the road to change bulbs is significant. In addition, there is no guarantee that a light that is working properly when a crew arrives won't burn out soon after the crew leaves, rendering a highway section unlit and more dangerous. Any system that minimizes the number of crews required to maintain these lights and the time these crews spend on the road will result in lower highway lighting and maintenance costs. While most highway lighting systems utilize more than one bulb in each fixture, these bulbs are used simultaneously, which fails to address all of the problems mentioned above.

The present invention is directed to overcoming one or more of the problems set forth above.

### SUMMARY OF THE INVENTION

An aspect of the present invention is to provide a highway light provided with an automatic backup lighting system.

In accordance with the above aspect of the invention, there is provided a highway light with an automatic backup lighting system that includes a voltage supply, a switching mechanism electrically connected with the voltage supply, a current sensing device electrically connected with the voltage supply and the switching mechanism, a primary lamp electrically connected with the current sensing device and the voltage supply, and a secondary lamp electrically connected with the switching mechanism, wherein the current sensing device activates the switching mechanism to direct voltage to the secondary lamp when the current sensing mechanism senses low amperage from its connection with the primary lamp.

A method for providing automatic backup lighting for a highway light includes electrically connecting a switching mechanism with a voltage supply; electrically connecting a current sensing device with the voltage supply and the switching mechanism; electrically connecting a primary lamp with the current sensing device and the voltage supply; electrically connecting a secondary lamp with the switching mechanism; providing voltage to the primary lamp; and switching the supply of voltage to the secondary lamp when the current sensing device senses low amperage in its connection with the primary lamp.

This aspect is merely illustrative aspects of the innumerable aspects associated with the present invention and should not be deemed as limiting in any manner. This and other aspects, features and advantages of the present invention will become apparent from the following detailed description when taken in conjunction with the referenced drawings.

### BRIEF DESCRIPTION OF THE DRAWINGS

Reference is now made more particularly to the drawings which illustrate the best presently known mode of carrying out the invention and wherein similar reference characters indicate the same parts throughout the views.

FIG. 1 is an electrical schematic of a highway light with an automatic backup system according to the present invention.

FIG. 2 is a schematic view of a highway light with an automatic backup system and primary and secondary lamps mounted within an enclosure according to another embodiment.

FIG. 3 is an electrical schematic of a highway light with an automatic backup system according to another embodiment.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

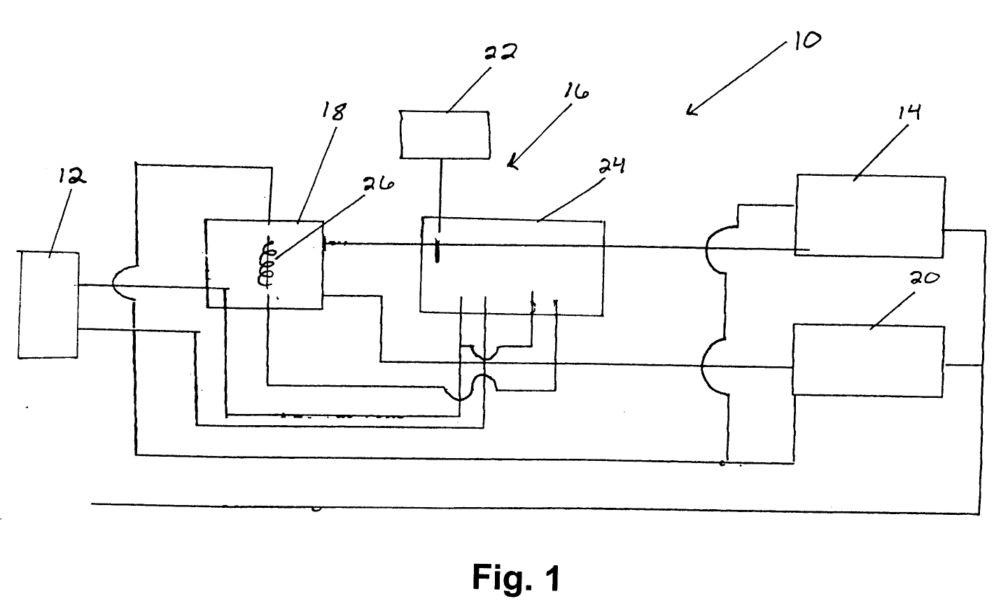

Referring now to the drawings, FIG. 1 illustrates an electrical schematic of a highway light 10 incorporating an automatic backup system. A voltage supply 12 provides electrical energy to the highway light 10. This voltage supply 12 can vary greatly depending on the light sources utilized.

The voltage supply 12 provides power to a primary lamp 14. A current sensing device 16 is electrically connected with the voltage supply 12 and the primary lamp 14. A switching mechanism 18 is electrically connected with the current sensing device 16 and the voltage supply 12. The switching mechanism 18 is also electrically connected with a secondary lamp 20. The primary and secondary lamps are preferably HVAC lamps, e.g., metal halide or sodium mercury vapor.

In the embodiment shown in FIG. 1, the current sensing device 16 includes a current transformer 22 and an ECS board 24. The switching mechanism 18 shown is a 120 volt powered relay. The voltage supply 12 provides power to the ECS board 24 and to the common terminal of the relay 18. Power then flows to the primary lamp 14 via the common and normally closed contacts of the relay 18. The ECS board 24 is also electrically connected at its normally open contact with the coil 26 of the relay 18. The secondary lamp 20 is electrically connected with the normally open contact of the relay 18.

In the event that the primary lamp 14 fails to light or burns out during operation, resulting in a drop in current across the ECS board 24 and current transformer 22, the ECS board closes its normally open contact, thereby transferring voltage to the coil 26 of the relay 18. This closes the normally open contact of the relay 18, thereby directing voltage to the secondary lamp 20.

While FIG. 1 illustrates a 120 volt system, it is also possible to adapt the backup system for use with a 240 volt power supply.

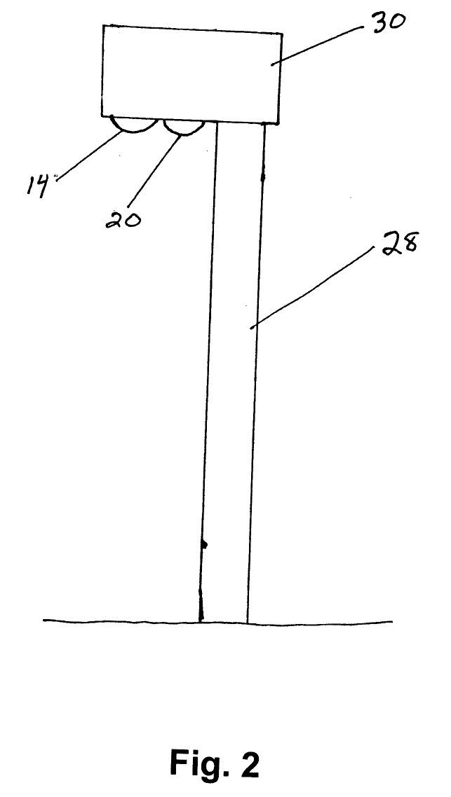

FIG. 2 illustrates one embodiment of a highway light incorporating an automatic backup lighting system. The highway light 10 includes a tower 28 at the top of which is mounted an enclosure 30. In the embodiment shown, the enclosure 30 houses both the primary lamp 14 and the secondary lamp 20 as well as the current sensing device and switching mechanism. The embodiment shown in FIG. 2 includes one primary lamp and one secondary lamp. However, alternate embodiments may include multiple primary and secondary lamps.

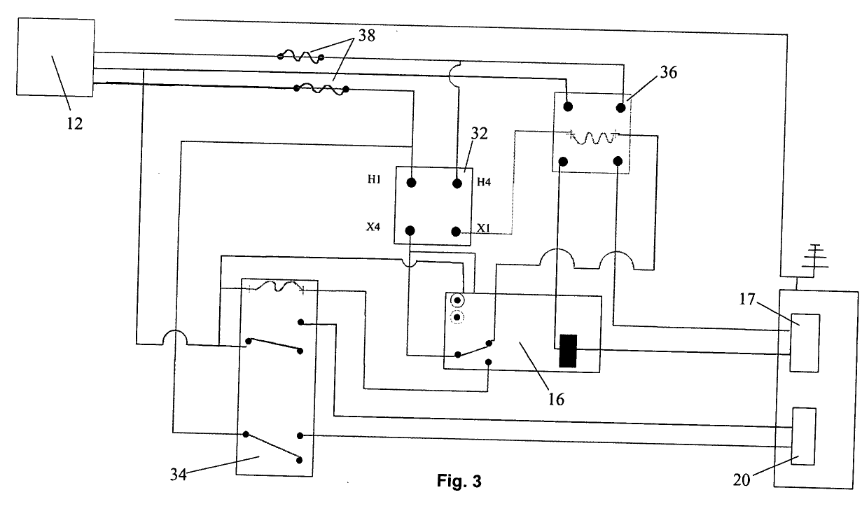

FIG. 3 illustrates a schematic of an embodiment suitable for use in circuits operating on voltages above 240 VAC. The primary addition in this embodiment is a voltage transformer 32. The same number of relays are used. However, in 480 volt systems, two power leads are advantageously used to provide the input to the 480-240 VAC transformer 32. The different voltages required for the remaining equipment in the circuit are then drawn from the transformer 32. At its lower tap, the transformer 32 provides 120 VAC for the ECS board 24 and a relay 34. The relay is advantageously a 120 VAC double throw, double pole relay. The neutral line provided with the source current is used to provide 277 VAC via a contactor 36. The neutral line also provides the center tap for all the lower voltages coming from the higher outputs. In one embodiment, the following events take place:

1. Fuse protection (38) is provided in the two lines of 480 VAC rated for the load of the primary and secondary lights.

2. A voltage of 480 AC is provided to the 480-240 VAC transformer.

3. The neutral line plus one leg of 480 VAC is provided to the contactor and supply is made available by the designed lighting techniques for activating the light's power supply.

4. The neutral side of the contactors conductor is passed through the Current Sensor on the ECS board 24 and then onto the light fixture power supply connected at the 277 VAC tap of the light's ballast.

5. The 480 VAC input to the transformer 32 is converted to 240 VAC output which is used to close the contactor to send the voltage to the primary light 14.

6. In the event that the light 14 does not come on or the load equivalent is not met, the ECS board 24 transfers the normally open contact to the closed position sending 120 VAC to the coil of the relay 18.

7. The relay 18 sends a neutral and the second leg of 480 VAC to the secondary light 20 activating it as a back up.

8. In the event of a power loss followed by a restoration of power, the secondary light 20 is put into service first. If enough time had lapsed during the power outage for the primary light 14 to cool down, then it is placed back into service first.

Other objects, features and advantages of the present invention will be apparent to those skilled in the art. While preferred embodiments of the present invention have been illustrated and described, this has been by way of illustration and the invention should not be limited except as required by the scope of the appended claims and their equivalents.

What is claimed is:

1. A highway light with an automatic backup lighting system, including:
a voltage supply;
a switching mechanism communicating with the voltage supply;
a current sensing device communicating with the voltage supply and the switching mechanism;
a primary lamp communicating with the current sensing device and the voltage supply;
a secondary lamp communicating with the switching mechanism; and
the current sensing device activating the switching mechanism to direct voltage to the secondary lamp when the current sensing mechanism senses low amperage from its connection with the primary lamp.

2. A highway light with an automatic backup lighting system as set forth in claim 1, further including an enclosure housing the primary lamp, the secondary lamp, the switching mechanism, the current sensing device, and the voltage supply.

3. A highway light with an automatic backup lighting system as set forth in claim 1, wherein the current sensing device includes a current transformer and an ECS board.

4. A highway light with an automatic backup lighting system as set forth in claim 1, wherein the switching mechanism includes a relay having a coil and common, normally closed and normally open terminals.

5. A highway light with an automatic backup lighting system as set forth in claim 4, wherein the current sensing device includes a current transformer and an ECS board having a normally open terminal communicating with the coil of the relay.

6. A highway light with an automatic backup lighting system as set forth in claim 4, wherein the relay includes a common terminal and wherein the voltage supply provides power to the current sensing device and to the common terminal of the relay.

7. A highway light with an automatic backup lighting system as set forth in claim 6, wherein the primary lamp communicates with the common and normally closed terminals of the relay.

8. A highway light with an automatic backup lighting system as set forth in claim 7, wherein the secondary lamp communicates with the normally open terminal of the relay.

9. A highway light with an automatic backup lighting system as set forth in claim 1, further including a voltage transformer communicating with the voltage supply, the switching mechanism and the current sensing device.

10. A method for providing automatic backup lighting for a highway light, including the steps of:
electrically connecting a switching mechanism with a voltage supply;
electrically connecting a current sensing device with the voltage supply and the switching mechanism;
electrically connecting a primary lamp with the current sensing device and the voltage supply;
electrically connecting a secondary lamp with the switching mechanism;
providing voltage to the primary lamp; and
switching the supply of voltage to the secondary lamp when the current sensing device senses low amperage in its connection with the primary lamp.

11. A method for providing automatic backup lighting for a highway light as set forth in claim 10, further including the step of providing an enclosure housing the voltage supply, the current sensing device, the switching mechanism, the primary lamp and the secondary lamp.

12. A method for providing automatic backup lighting for a highway light as set forth in claim 10, wherein the step of electrically connecting the current sensing device with the voltage supply and the switching mechanism includes providing a current transformer and an ECS board as part of the current sensing device and connecting a normally open terminal in the ECS board with the switching mechanism.

13. A method for providing automatic backup lighting for a highway light as set forth in claim 10, wherein the step of electrically connecting the switching mechanism with the voltage supply includes providing a relay as part of the switching mechanism and connecting the voltage supply with a common terminal of the relay.

14. A method for providing automatic backup lighting for a highway light as set forth in claim 13, wherein the step of electrically connecting the primary lamp with the current sensing device and the switching mechanism includes connecting the primary lamp with the common terminal and a normally open terminal of the relay.

15. A method for providing automatic backup lighting for a highway light as set forth in claim 13, wherein the step of electrically connecting the secondary lamp with the switching mechanism includes connecting the secondary lamp with a normally open terminal of the relay.

16. A method for providing automatic backup lighting for a highway light as set forth in claim 10, further including the step of electrically connecting a voltage transformer to the voltage supply, the switching mechanism, and the current sensing device.

17. A backup lighting circuit for a highway light having a voltage supply and a primary lamp, including:
a powered relay communicating with the voltage supply, said relay having a coil, and common, normally closed and normally open terminals and wherein the common terminal is connecting to the voltage supply and the common and normally closed terminals are connected with the primary lamp;
a current sensing device having a current transformer and an ECS board and communicating with the voltage supply, the switching mechanism and the primary lamp, said ECS board having a normally open terminal connected with the coil of the relay;
a secondary lamp connected with the normally open terminal of the relay; and
the current sensing device activating the relay to direct voltage to the secondary lamp when the current sensing mechanism senses low amperage from its connection with the primary lamp.

18. A backup lighting circuit for a highway light as set forth in claim 17, further including a voltage transformer communicating with the voltage supply, the switching mechanism, and the current sensing device.
